(19) United States
(12) Patent Application Publication
(10) Pub. No.: US 2019/0279529 A1
(43) Pub. Date: Sep. 12, 2019

(54) PORTABLE ROBOT FOR TWO-WAY COMMUNICATION WITH THE HEARING-IMPAIRED

(71) Applicant: KING SAUD UNIVERSITY, RIYADH (SA)

(72) Inventors: MOHAMMED MAHDI AHMED AL-GABRI, RIYADH (SA); MANSOUR MOHAMMED A. ALSULAIMAN, RIYADH (SA); HASSAN ISMAIL H. MATHKOUR, RIYADH (SA); MOHAMED ABDELKADER BENCHERIF, RIYADH (SA); MOHAMMED FAISAL ABDULQADER NAJI, RIYADH (SA); MOHAMED AMINE MEKHTICHE, RIYADH (SA); GHULAM MUHAMMAD, RIYADH (SA); WADOOD ABDUL, RIYADH (SA)

(21) Appl. No.: 15/916,198

(22) Filed: Mar. 8, 2018

(51) Int. Cl. G09B 21/00; B25J 9/00; B25J 9/16; B25J 11/00; G10L 13/04; G10L 15/26

(52) U.S. Cl. CPC G09B 21/009; B25J 9/0087; B25J 9/1697; B25J 9/1682; B25J 9/1669; B25J 11/0015; H04W 4/80; B25J 11/008; G10L 13/043; G10L 15/265; Y10S 901/09; Y10S 901/15; Y10S 901/47; B25J 11/001

(57) ABSTRACT

The portable robot for two-way communication with the hearing-impaired provides for translation of audio into hand movements, hand shapes, hand orientations; the location of the hands around the body, the movements of the body and the head, facial expressions and lip movements to provide communication from a non-hearing-impaired individual(s) to hearing-impaired individual(s). The robot also translates hand movements, hand shapes, hand orientations; the location of the hands around the body, the movements of the body and the head, facial expressions and lip movements into audio to provide communication from hearing-impaired individual(s) to non-hearing-impaired individual(s). A communication system is provided to allow remote communication with non-hearing-impaired individual(s).

### BACKGROUND

### 1. Field

The disclosure of the present patent application relates to robotic equipment, and particularly to a portable robot for two-way communication with the hearing-impaired.

### 2. Description of the Related Art

A sign language for the hearing impaired is a visual language that is composed of combinations of hand gestures, facial expressions, and head movements. The hearing-impaired face many difficulties to interact with society all over the world, centered on the difficulty of communicating with individuals that do not know sign language. As an example, Arabic sign language is made up of hand movements, hand shapes, hand orientations; the location of the hands around the body, the movements of the body and the head, facial expressions and may be lip movements. While there are robotic devices that can reproduce some of the above movements, none of the prior art devices provide two-way communications using all of the above features, and therefore cannot always provide an accurate translation. Moreover, none of the prior art devices provide remote communication through a telephone network.

Thus, a portable robot for two-way communication with the hearing-impaired solving the aforementioned problems is desired.

### SUMMARY

The portable robot for two-way communication with the hearing-impaired provides for translation of audio into hand movements, hand shapes, hand orientations; the location of the hands around the body, the movements of the body and the head, facial expressions and lip movements of sign language to provide communication from a non-hearing-impaired individual(s) to hearing-impaired individual(s). The robot also translates hand movements, hand shapes, hand orientations; the location of the hands around the body, the movements of the body and the head, facial expressions and lip movements of sign language into audio to provide communication from hearing-impaired individual(s) to non-hearing-impaired individual(s). A wireless communication system is also provided to allow remote communication with non-hearing-impaired individual(s) through a telephone network.

The portable robot for two-way communication with the hearing-impaired, includes: a base; a torso mounted on the base via a first connection, the torso having a generally planar triangular configuration including a front, a back, a bottom, a left top, a right top and a center top; a left arm mounted with a proximate end attached to the left top of the torso via a first shoulder joint and including a first elbow joint and a left hand mounted on a distal end of the left arm via a first wrist joint, the left hand having a first little finger, a first ring finger; a first middle finger, a first index finger and a first thumb, the fingers each being moved by a first servo motor or motors controlled by a first servo controller; a right arm mounted with a proximate end attached to the right top of the torso via a second shoulder joint and including a second elbow joint and a right hand mounted on a distal end of the right arm via a second wrist joint, the right hand having a second little finger, a second ring finger; a second middle finger, a second index finger and a second thumb, the fingers each being moved by a second servo motor or motors controlled by a second servo controller; a head rotatably mounted on the center top of the torso via a neck joint, the head including a front surface a first side surface, a second side surface, a first display screen mounted on the front surface, a 3D camera mounted on the front surface, a microphone mounted on the front surface, and a first speaker mounted on the first side surface; and a control system having a vision-based active recognition module, a speech processing module, and a robot control and sign language generation module.

These and other features of the present disclosure will become readily apparent upon further review of the following specification and drawings.

### BRIEF DESCRIPTION OF THE DRAWINGS

FIG. 1 is a perspective view of a portable robot for two-way communication with the hearing-impaired.

FIG. 2 is a rear view of the portable robot of FIG. 1.

FIG. 3 is a schematic diagram showing the degrees of freedom for the various joints of the body of the portable robot of FIG. 1.

FIG. 4 is a top view of a hand and forearm of the portable robot of FIG. 1, the housing being removed to show the internal components.

FIG. 5 is a schematic diagram showing the degrees of freedom for the various joints of the right hand of the portable robot of FIG. 1.

FIG. 6 is a block diagram showing the system components of a control system for the portable robot of FIG. 1, for face-to-face communications.

FIG. 7 is a block diagram showing the system components of a control system for the portable robot of FIG. 1, for remote communications.

FIG. 8 is a flowchart of the speech-to-text portion of the speech processing module of FIGS. 6 and 7.

FIG. 9 is a flowchart of the text-to-speech portion of the speech processing module of FIGS. 6 and 7.

FIG. 10 is a flowchart of the vision-based active recognition module of FIGS. 6 and 7.

FIG. 11 is a flowchart of the robot control for sign language module of FIGS. 6 and 7.

FIG. 12 is a chart including a front view of the portable robot of FIG. 1, showing the robot performing a sign that requires a hand back pose.

FIG. 13 is a chart including a front view of the portable robot of FIG. 1, showing the robot performing a sign that requires a hand front pose.

FIG. 14 is a chart including a front view of the portable robot of FIG. 1, showing the robot performing a sign that requires movement of one hand.

FIG. 15 is a chart including a front view of the portable robot of FIG. 1, showing the robot performing a sign that requires movement of both hands.

FIG. 16 is a chart including a front view of the portable robot of FIG. 1, showing the robot performing a sign that requires pose of both hands.

FIG. 17 is a chart including a front view of the portable robot of FIG. 1, showing the robot performing a sign that requires movement of both hands and the head.

FIG. 18 is a chart including a front view of the portable robot of FIG. 1, showing the robot performing a sign that requires movement of one hand and the body.

FIG. 19 is a chart including a front view of the portable robot of FIG. 1, showing the robot performing a sign that requires movement of one hand and facial expression.

FIG. 20 is a chart including a front view of the portable robot of FIG. 1, showing the robot performing a sign that requires pose of one hand and movement of the other hand and the head.

Similar reference characters denote corresponding features consistently throughout the attached drawings.

### DETAILED DESCRIPTION OF THE PREFERRED EMBODIMENTS

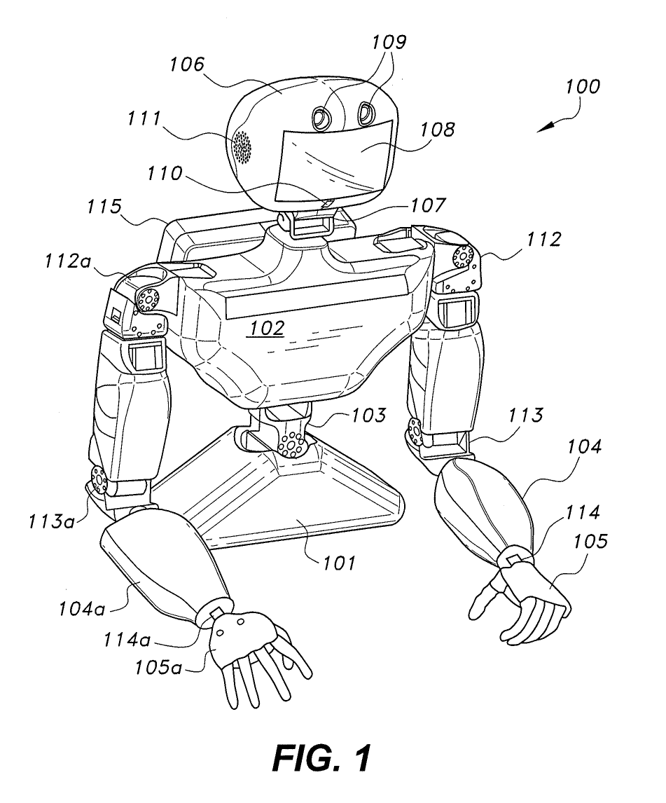

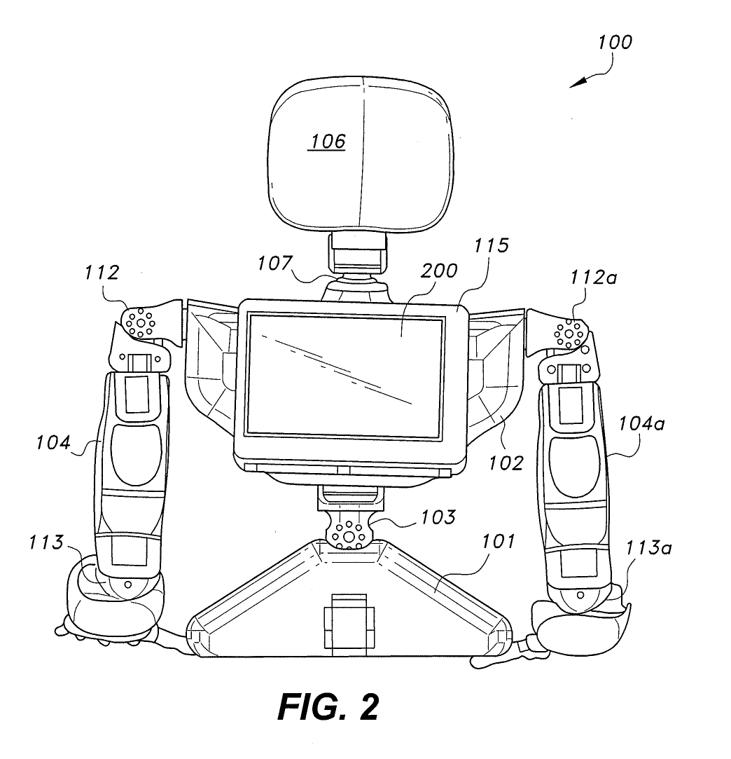

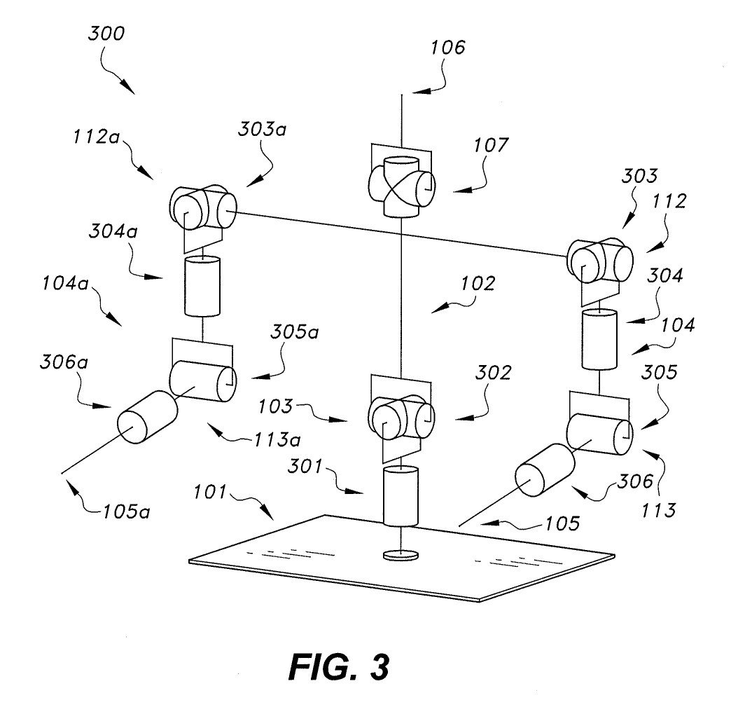

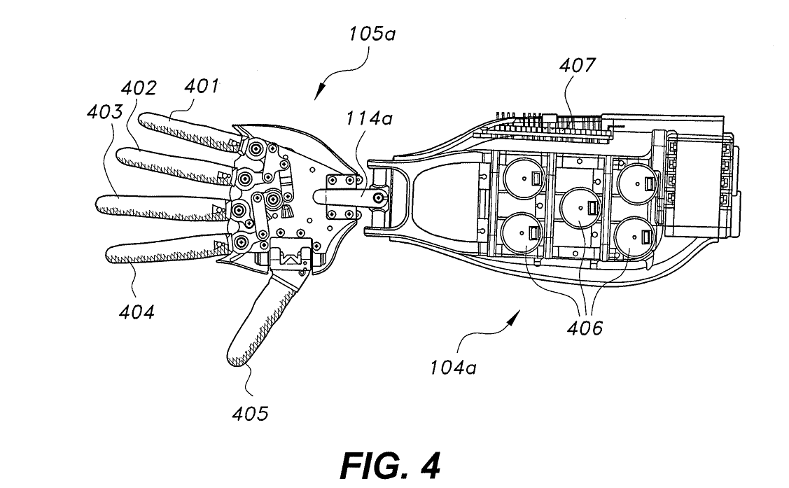

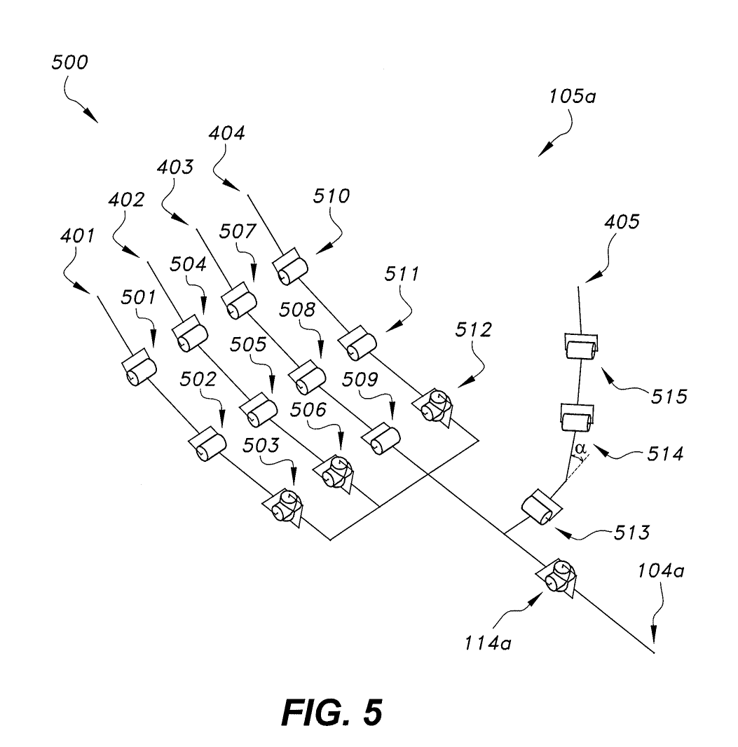

The portable robot for two-way communication with the hearing-impaired, designated generally as 100 in the drawings, is shown in FIGS. 1 and 2. The front of the robot 100 is best seen in FIG. 1. The front of the robot 100 is intended to face the hearing-impaired and non-hearing impaired individual or individuals taking part in the conversation. The robot includes a base 101 for supporting the robot 100 on a substantially horizontal surface. The base 101can be replaced with a transportation system, similar to two-wheeled mobile robots. A torso 102 is mounted on the base 101 via a two joint connection 103 that provides rotation about three axes, as described below with respect to FIG. 3. A left arm 104 and a right arm 104a are mounted near the top of the torso 102 via shoulder joints 112 and 112a, respectively. The arms 104 and 104a also include elbow joints 113 and 113a, respectively. The arms 104 and 104a have freedom of movement similar to human arms, as described in more detail below with respect to FIG. 3. The left arm 104 includes a left hand 105, and the right arm 104a includes a right hand 105a rotatably attached to their distal ends via wrist joints 114 and 114a, respectively. The hands 105 and 105a and wrists 114 and 114a, have freedom of movement similar to human arms, as is described in more detail below with respect to FIGS. 4-5.

A head 106 is rotatably mounted on the top center of the torso 102 via a two degree of freedom (DOF) joint 107, as described further below with respect to FIG. 3. The front of the head 106 includes a display screen 108 for displaying text, facial expressions or a combination of both to the hearing-impaired individual or individuals or displaying text to the non-hearing-impaired individual or individuals in the case when both of the non-hearing-impaired and hearing-impaired individual or individuals are facing the front of the robot. The front of the head 106 also includes: a 3D camera 109 having an RGB and depth camera to read the sign language motions or the lips of the hearing-impaired individual or individuals; and a microphone 110 for listening to speech of the non-hearing-impaired individual or individuals. The sides of the head 106 each have a speaker 111 for audio output of the translated words.

The back of the robot 100 is best seen in FIG. 2. The back of the robot 100 is intended to face the non-hearing-impaired individual or individuals, taking part in the conversation in the cases when the robot 100 is between the non-hearing-impaired individual or individuals and the hearing-impaired individual or individuals. The back of the robot includes a housing 115, similar in appearance to a back pack. The housing 115 includes a rear facing display screen 200 for displaying the translated sign language to the non-hearing-impaired individual or individuals, in addition to the audio output by the speaker 111.

FIG. 3 shows a schematic diagram 300 of the various joints of the head 106, torso 102 and arms 104 and 104a. Joint 103 that connects the torso 102 to the base includes a first single degree of freedom joint 301 for rotating the torso 102 about the z-axis relative to the base 101, and a second two-degree of freedom joint 302 for rotating the torso 102 about the x- and y-axes relative to the base 101. Joint 107 is a two-degree of freedom joint for rotating the head 106 about the z- and y-axes relative to the torso 102. The left arm 104 is attached to the torso 102 via a shoulder joint 112 that includes a two-degree of freedom joint 303 for rotating the left arm 104 about the x- and y-axes relative to the torso 102, and a single degree of freedom joint 304 for rotating the left arm 104 about the z-axis (the longitudinal axis of the upper arm). The elbow joint 113 includes a first single degree of freedom joint 305 for rotating the forearm relative to the upper arm about the y-axis and a second single degree of freedom joint 306 for rotating the forearm relative to the upper arm about the z-axis (the longitudinal axis of the forearm). Similarly, the right arm 104a is attached to the torso 102 via a shoulder joint 112a that includes a two-degree of freedom joint 303a for rotating the right arm 104a about the x- and y-axes relative to the torso 102, and a single degree of freedom joint 304a for rotating the right arm 104a about the z-axis (the longitudinal axis of the upper arm). The elbow joint 113a includes a first single degree of freedom joint 305a for rotating the forearm relative to the upper arm about the y-axis and a second single degree of freedom joint 306a for rotating the forearm relative to the upper arm about the z-axis (the longitudinal axis of the forearm).

FIG. 4 shows some of the internal components of one embodiment of the right arm 104a and right hand 105a in a palm down orientation. While the following discussion is with respect to the right arm 104a and right hand 105a, it should be understood that it applies to the left arm 104 and left hand 105 as well, the left arm 104 and left hand 105 being a mirror image of the right arm 104a and right hand 105a. The right hand 105a includes five fingers: little finger 401; ring finger 402; middle finger 403; index finger 404; and thumb 405. The fingers are moved by seven servo motors: five servo motors 406 for the flexion and the extension movements of each finger, one servo motor for thumb abduction and adduction movements, and one servo motor for abduction and adduction movements of the other four fingers. All seven servo motors are controlled by a servo controller 407.

FIG. 5 shows a schematic diagram 500 of the various joints of the fingers and wrist associated with the right hand 105a in a palm up orientation. The wrist joint 114a is a two-degree of freedom joint, allowing rotation of the hand about the y- and z-axes relative to right arm 104a. The five fingers 401-405 are attached to the wrist joint 114a. The little finger 401 includes a single degree of freedom distal interphalangeal joint 501, a single degree of freedom proximal interphalangeal joint 502 and a two-degree of freedom metacarpophalangeal joint 503 for rotation of the little finger 401 around the y- and z-axes. The ring finger 402 includes a single degree of freedom distal interphalangeal joint 504, a single degree of freedom proximal interphalangeal joint 505 and a two-degree of freedom metacarpophalangeal joint 506 for rotation of the ring finger 402 around the y- and z-axes. The middle finger 403 includes a single degree of freedom distal interphalangeal joint 507, a single degree of freedom proximal interphalangeal joint 508 and a single degree of freedom metacarpophalangeal joint 509, as the middle finger 403 remains aligned with the wrist in all positions. The index finger 404 includes a single degree of freedom distal interphalangeal joint 510, a single degree of freedom proximal interphalangeal joint 511 and a two-degree of freedom metacarpophalangeal joint 512 for rotation of the index finger 404 around the y-and z-axes. The thumb 405 includes a single degree of freedom distal interphalangeal joint 515, a single degree of freedom proximal interphalangeal joint 514, and a single degree of freedom metacarpophalangeal joint 513, as the thumb 405 remains aligned with the wrist in all positions at an angle substantially perpendicular to the middle finger 403. The proximal interphalangeal joint 514 and the metacarpophalangeal joint 513 of the thumb 405 are at an acute angle a to one another, such that the thumb 405 crosses the center of the palm, in the same manner as a human thumb.

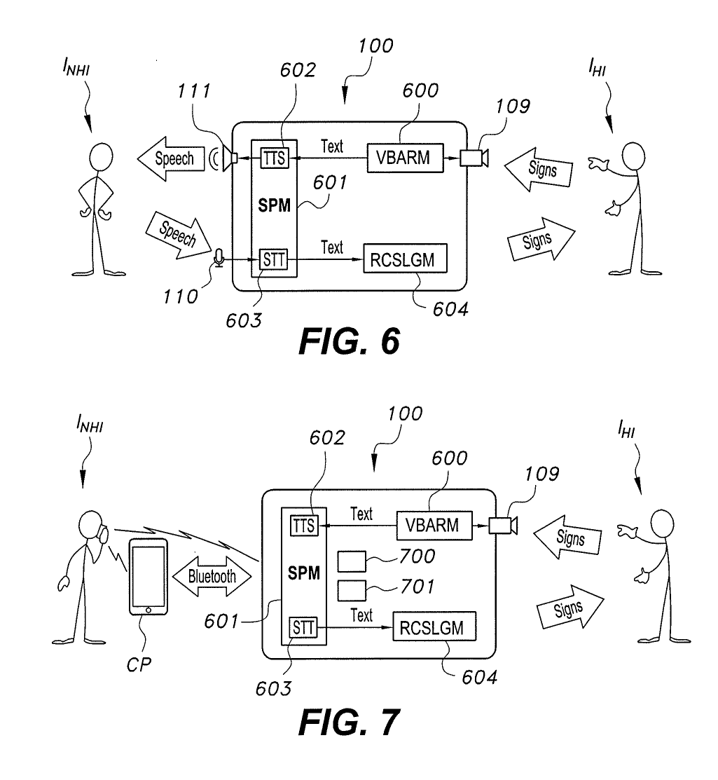

FIG. 6 shows a block diagram of a control system for the portable robot 100 for two-way face-to-face communications between a hearing-impaired individual I_{HI} and a non-hearing-impaired individual I_{NHI}, showing various components of the robot 100. The components include a vision-based active recognition module (VBARM) 600; a speech processing module (SPM) 601 including a text-to-speech (TTS) module 602 and a speech-to-text (STT) module 603; and a robot control and sign language generation module (RCSLGM) 604. The details of the modules 600-604 are described in greater detail with respect to FIGS. 8-11.

For communications from the hearing-impaired individual I_{HI} to the non-hearing-impaired individual I_{NHI}, the VBARM 600 first receives a video signal from the camera 109 facing the hearing-impaired individual I_{HI} and analyzes the data to recognize sign language and translates the signs into text data. This text data is sent to the SPM where the TTS module 602 provides audio to the speaker 111 to let the robot 100 enunciate what the deaf person has communicated by sign language. In addition, the text may also be displayed on the video screen facing the non-hearing-impaired individual I_{NHI}, screen 108 (Fig.1) or screen 200 (FIG. 2). The 3D camera 109 includes an RGB camera and a depth camera, which provides superior performance to recognize the sign performed by isolated and/or continuous hand and body gestures and facial expressions. These gestures and facial expressions are then compared to video databases for translation to the text they represent.

For communications from the non-hearing-impaired individual I_{NHI} to the hearing-impaired individual I_{HI}, the microphone 110 receives an audio signal from the non-hearing-impaired individual I_{NHI} comprising text. The audio signal is sent to the SPM where the STT module 603 converts the audio into text data. This text data is sent to the RCSLGM 604, which converts the recognized words into the required motions to perform the sign. The recognized words can be looked up in the database for translation to the gestures and facial expressions they represent.

FIG. 7 shows a block diagram of a control system for the portable robot 100 for two-way remote communications between a hearing-impaired individual I_{HI} and a non-hearing-impaired individual I_{NHI}, showing the various components of the robot 100. The components include the same components as the face-to-face embodiment shown in FIG. 6, namely: a vision-based active recognition module (VBARM) 600; a speech processing module (SPM) 601 including a text-to-speech (TTS) module 602 and a speech-to-text (STT) module 603; and a robot control and sign language generation module (RCSLGM) 604. In addition to the above modules, the portable robot 100 for two-way remote communications includes a communication system (CS) having an embedded telephone module 700 and a Bluetooth module 701. The embedded telephone module 700 includes a fully functional embedded mobile phone that uses a subscriber identification module (SIM) card. The microphone and speaker of the non-hearing-impaired individual I_{NHI}'s remote telephone (mobile or fixed) will be connected to the robot microphone 110 and speaker 111, respectively. The back screen of the robot is a fully functional screen for the embedded mobile, allowing the hearing-impaired individual I_{HI} to make and accept calls. The embedded telephone module 700 may also communicate through a fixed line with a wired connection between the telephone speaker and robot microphone 110 and the robot speaker 111 and the telephone microphone, respectively. The Bluetooth module 701 provides a Bluetooth connection between a local cell phone CP mobile speaker and the robot microphone 110 and the robot speaker 111 and the CP mobile microphone, respectively. The microphone and speaker of the non-hearing-impaired individual I_{NHI}'s remote telephone (mobile or fixed) is then connected to the robot microphone 110 and speaker 111, respectively, via the local cell phone CP.

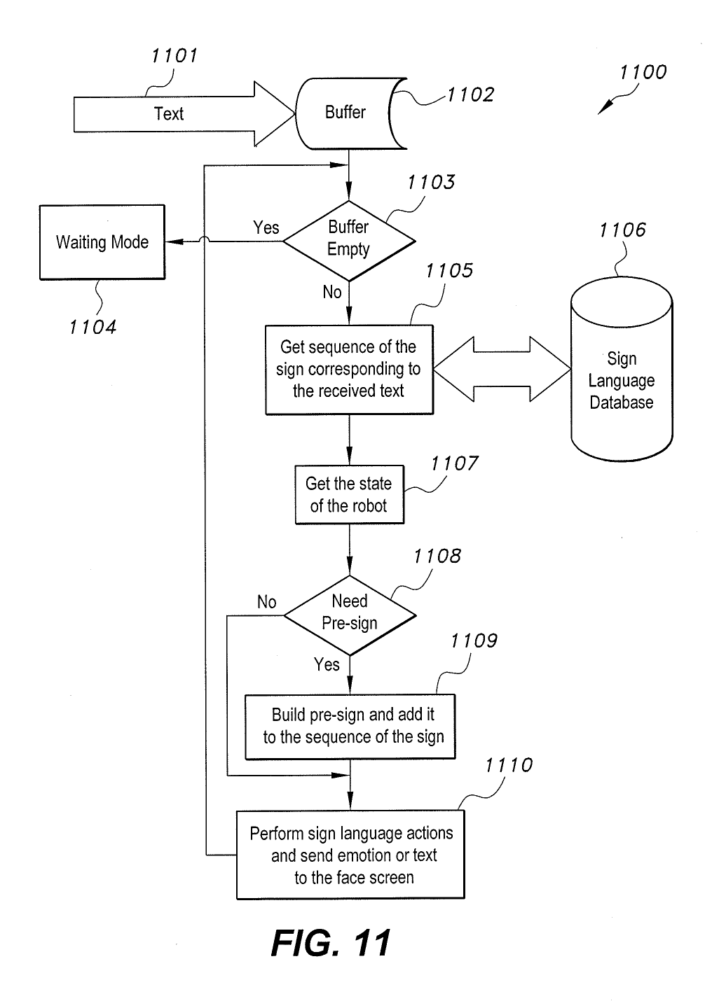

FIG. 8 shows a flowchart 800 of the functions of the speech-to-text (STT) module 603 of the speech processing module (SPM) 601. In step 801, audio is received by the robot microphone 110, or via the embedded telephone module 700 or the Bluetooth module 701, as described above. At step 802, the audio is analyzed to determine if speech is present in the audio. In the determination step 803, if speech is detected, the speech is segmented at step 804. If speech is not detected, the process returns to step 802, and the next available audio is analyzed to determine if speech is present in the new audio. This process continues until speech is detected. After detected speech has been segmented, the segments are recognized as their corresponding phonemes in step 805. This is done by comparing the segments with a segment/phoneme speech database 806, which may be in local memory or remote memory on the Internet (on-line). Once the phonemes have been recognized, they are concatenated into text at step 807. At step 808, the text is sent to the robot control and sign language generation module (RCSLGM) 604 for translation into the appropriate hand, torso and head movements as well as the appropriate facial expression and/or text on the display screen 108, as described in further detail below with respect to FIG. 11.

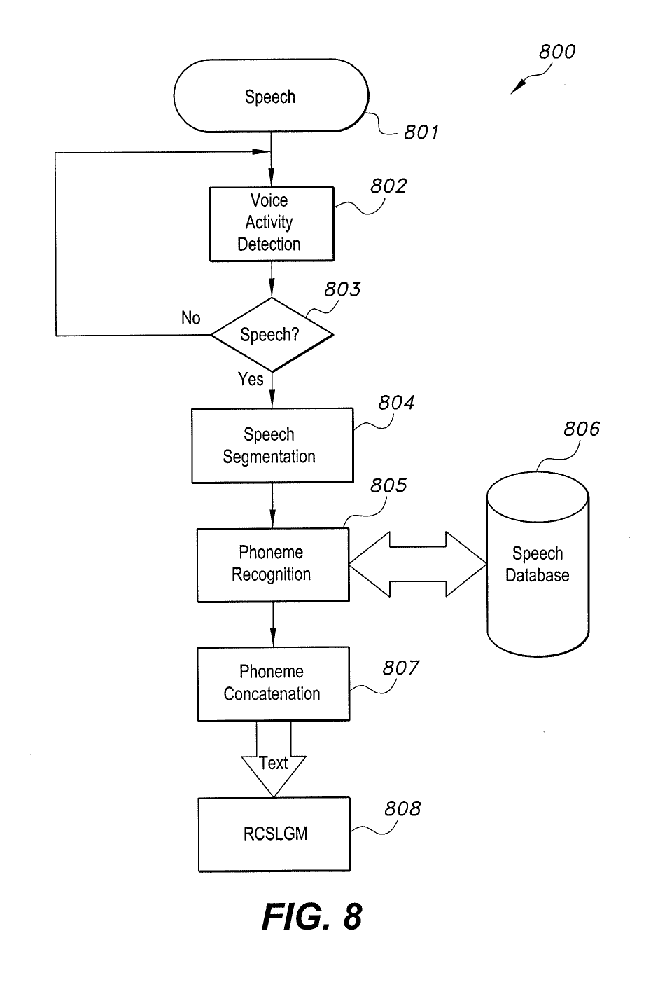

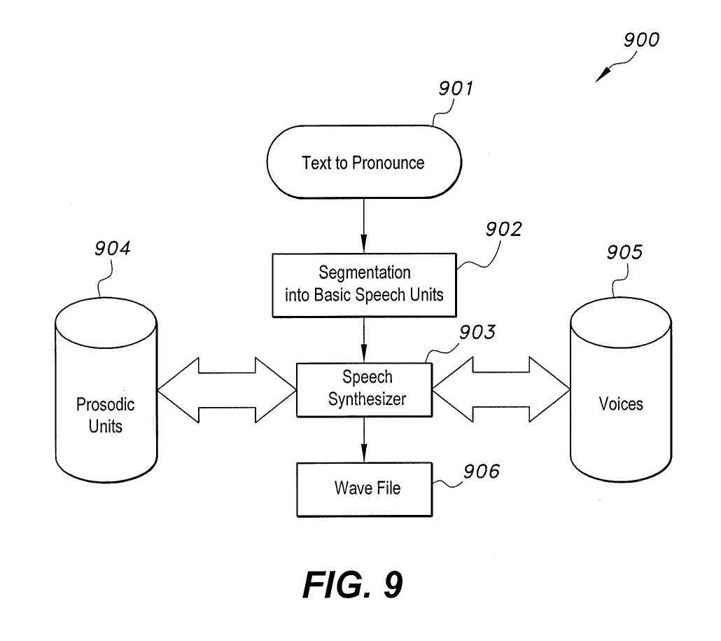

FIG. 9 shows a flowchart 900 of the functions of the text-to-speech (TTS) module 602 of the speech processing module (SPM) 601. At step 901, the text is received from the vision-based active recognition module (VBARM) 600. At step 902, the received text is segmented into basic speech units. At step 903, the speech is synthesized using the speech units, a prosodic units database 904, and a voices database 905. The databases 904 and 905 may be in local memory or remote memory on the Internet (on-line). In step 906, the synthesized speech is sent as a wave file to the speaker 111 (via an appropriate amplifier) and to the communication system (CS) for remote communication, as described above.

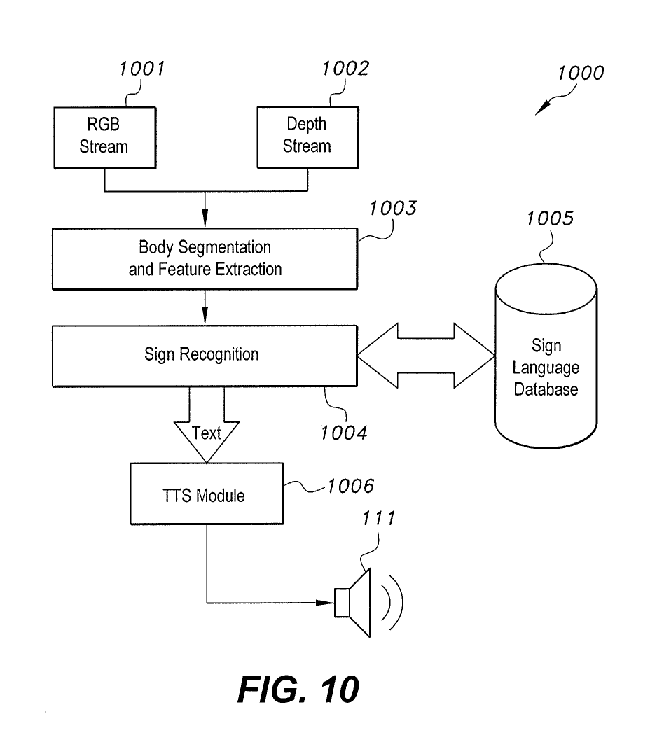

FIG. 10 shows a flow chart 1000 of the functions of the vision-based active recognition module (VBARM) 600. At steps 1001 and 1002, video is received simultaneously from the RGB and depth camera portions, respectively, of the 3D camera 109, which is facing the hearing-impaired individual I_{HI}. At step 1003, the video is analyzed for body segmentation and feature extraction. At step 1004, the movement of the body segments and the extracted features are compared with a sign language database 1005 to recognize sign language and translate the signs into text data. The database 1005 may be in local memory or remote memory on the Internet (on-line). At step 1006, the text data is sent to the text-to-speech (TTS) module 602 for conversion to audio. The audio is then sent to the speaker 111 (via an appropriate amplifier) and to the communication system (CS) for remote communication, as described above.

FIG. 11 shows a flowchart 1100 of the functions of the robot control and sign language generation module (RCSLGM) 604. At step 1101 text is received from the speech-to-text (SIT) module 603 and placed in a memory buffer 1102. At step 1103, it is determined if the buffer is empty. If the buffer empty, the process enters a waiting mode 1104 and periodically checks the buffer memory 1102 for contents. If the buffer is not empty, then the process proceeds to step 1105, where the text in the buffer is compared with a sign language database 1106 to determine the sequence of signs that corresponds to the received text. The sign language database 1106 may be in local memory or remote memory on the Internet (on-line). At step 1107, the state of the robot (head, torso, arms, hands and fingers positions) is determined. At step 1108, it is determined if a pre-sign is needed, depending on the sequence of signs and the determined state of the robot. If a pre-sign is needed, the process proceeds to step 1109, where the pre-sign is built and added at the beginning of the sequence of signs to form the final sequence of signs, and then the process proceeds to step 1110. If a pre-sign is not needed, the process proceeds directly to step 1110. At step 1110, the sign language actions are performed using the appropriate servo motors and facial expressions, and/or text is sent to the display screen 108.

### EXAMPLE 1

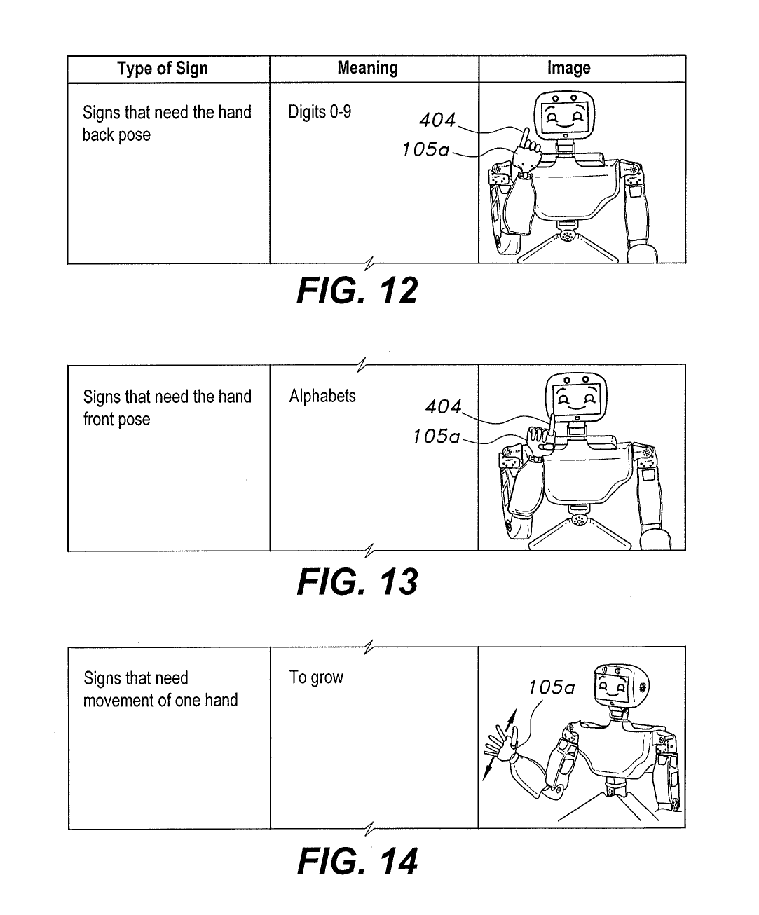

In FIG. 12, an example of a sign that requires a hand back pose is shown. In this example, the back of hand 105a is directed to the hearing-impaired individual I_{HI} and the index finger 404 is raised to indicate digit “1.”

### EXAMPLE 2

In FIG. 13, an example of a sign that requires a hand front pose is shown. In this example, the palm of hand 105a is directed to the hearing-impaired individual I_{HI} and the index finger 404 is raised to indicate Arabic letter “b.”

### EXAMPLE 3

In FIG. 14, an example of a sign that requires the movement of one hand is shown. In this example, the palm of hand 105a is directed to the hearing-impaired individual and the hand 105a is moved up and down to indicate “to grow.”

### EXAMPLE 4

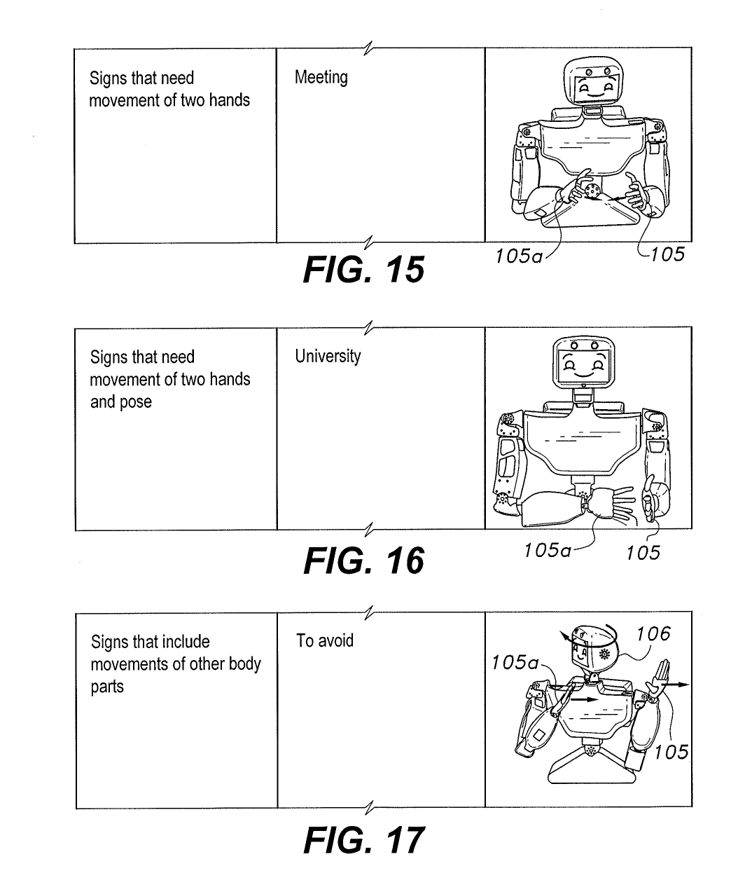

In FIG. 15, an example of a sign that requires the movement of two hands is shown. In this example, the palms of the hands 105 and 105a are directed toward one another and the hands 105 and 105a are moved toward each other to indicate “meeting.”

### EXAMPLE 5

In FIG. 16, an example of a sign that requires the movement of two hands and a pose is shown. In this example, the back of hand 105a is directed to the hearing-impaired individual I_{HI} and the palm of hand 105 is directed toward the hand 105a, to indicate “University.”

### EXAMPLE 6

In FIG. 17, an example of a sign that requires the movement of other body parts is shown. In this example, the palms of hands 105 and 105a are directed to the left of the robot, the hands 105 and 105a are moved to the left and the head 106 is rotated to the right to indicate “to avoid.”

### EXAMPLE 7

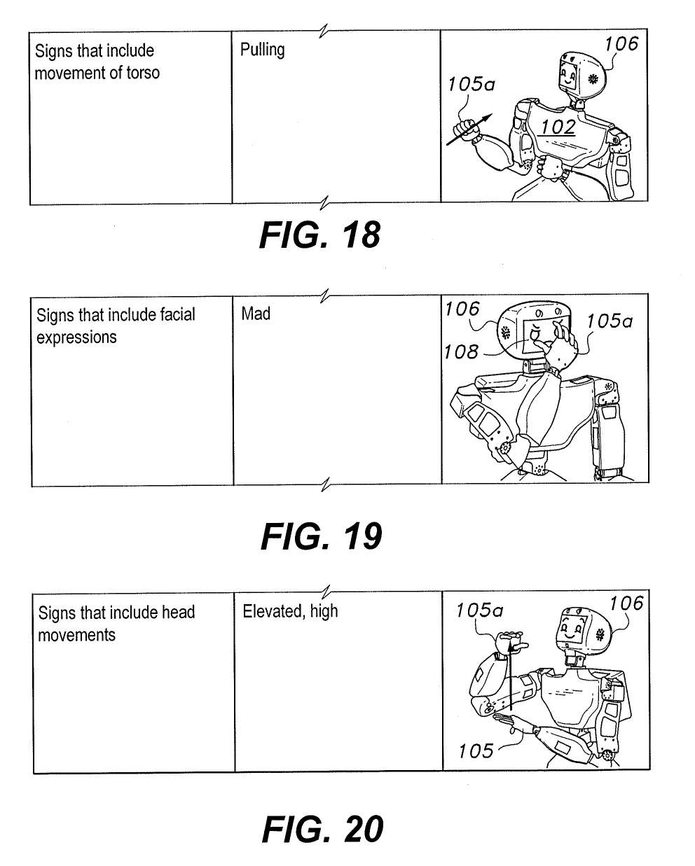

In FIG. 18, an example of a sign that requires the movement of the torso is shown. In this example, the fingers of the hand 105a are flexed closed, the hand 105a is pulled toward the robot's head 106, the head is turned slightly to the right and the torso is rotated to the right and leaned backwards to indicate “pulling.”

### EXAMPLE 8

In FIG. 19, an example of a sign that requires facial expressions is shown. In this example, the fingers of the hand 105a are held in a cup-shaped pose directly in front of the display screen 108 on the head 106, while an angry facial expression is displayed on the display screen 108 to indicate “mad.”

### EXAMPLE 9

In FIG. 20, an example of a sign that requires head movement is shown. In this example, the head 106 is tilted backwards, while hand 105a is moved upward over hand 105 to indicate “elevated, high.”

It is to be understood that the portable robot for two-way communication with the hearing-impaired is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A portable robot for two-way communication between a non-hearing impaired user and a hearing-impaired user, the portable robot comprising:
a base;
a first connection;
a torso mounted on the base via the first connection, the torso having a generally planar triangular configuration including a front, a back, a bottom, a left top, a right top and a center top;
a left arm and a first shoulder joint, the left arm having a proximate end and a distal end, the proximate end being mounted to the left top of the torso via the first shoulder joint, the left arm including a first elbow joint;
a left hand and a first wrist joint, the left hand being mounted on the distal end of the left arm via the first wrist joint, the left hand having a first little finger, a first ring finger; a first middle finger, a first index finger and a first thumb;
at least one first servo motor and a first servo controller connected to the first servo motor, the fingers each being connected to and moved by the at least one first servo motor as controlled by the first servo controller;
a right arm and a second shoulder joint, the right arm having a proximate end and a distal end, the proximate end being mounted to the right top of the torso via the second shoulder joint, the right arm including a second elbow joint;
a right hand and a second wrist joint, the right hand being mounted on the distal end of the right arm via the second wrist joint, the right hand including a second little finger, a second ring finger; a second middle finger, a second index finger and a second thumb;
at least one second servo motor and a second servo controller, the fingers each being connected to and moved by the at least one second servo motor as controlled by the second servo controller;
a neck joint;
a head rotatably mounted on the center top of the torso via the neck joint, the head having a front surface facing the hearing impaired user, a first side surface, a second side surface, a first display screen mounted on the front surface, a 3D camera mounted on the front surface, a robot microphone mounted on the front surface, a first robot speaker mounted on the first side surface and a second robot speaker mounted on the second side surface;
a housing mounted on the back of the torso, the housing having a second display screen mounted thereon and facing the non-hearing impaired user; and
a control system including a vision-based active recognition module, a speech processing module having a text-to-speech module and a speech-to-text module, and a robot control and sign language generation module; wherein:
the vision-based active recognition module receives a video signal from the 3D camera and compares gestures and facial expressions in the video signal to video databases to translate the gestures and facial expressions of the hearing impaired user to a translated text, wherein the translated text is displayed on the second display screen;
the text-to-speech module receives the translated text from the vision-based active recognition module and synthesizes the translated text into synthesized speech;
the synthesized speech is sent to the first and second speakers;
the robot microphone receives an audio signal from the non-hearing impaired user and sends the audio signal to the speech-to-text module;
the speech-to-text module segments any speech detected in the audio signal into speech segments;
the segments are recognized as their corresponding phonemes by comparing the segments with a segment/phoneme speech database;
the corresponding phonemes are concatenated into concatenated text;
the concatenated text is sent to the robot control and sign language generation module;
the robot control and sign language generation module controls: the first display screen to provide facial expressions associated with the concatenated text; and the first and the second servo controllers to provide at least hand and finger movements associated with the concatenated text.

2. (canceled)

3. The portable robot according to claim 1, wherein the 3D camera comprises an RGB and a depth camera.

4. (canceled)

5. The portable robot according to claim 1, further comprising a communication system mounted on the torso, the communication system having: an embedded telephone module that connects a microphone of a remote telephone to the robot microphone and connects a speaker of the remote telephone to the first and second robot speakers and a wireless module adapted to connect a local cell phone's mobile speaker to the robot microphone and the robot speaker and the local cell phone's mobile microphone.

6. (canceled)

7. The portable robot according to claim 5, wherein the embedded telephone module further comprises a fixed line with a wired connection for wired communications with the remote telephone.

8. The portable robot according to claim 1, wherein the first connection comprises a first single degree of freedom joint for rotating the torso about a z-axis relative to the base and a first two-degree of freedom joint for rotating the torso about x- and y-axes relative to the base.

9. The portable robot according to claim 8, wherein the neck joint is a second two-degree of freedom joint for rotating the head about z- and y-axes relative to the torso.

10. The portable robot according to claim 1, wherein:
the left arm has an upper arm portion and a forearm portion, and the first shoulder joint comprises a third two-degree of freedom joint for rotating the left arm about x- and y-axes relative to the torso, and a second single degree of freedom joint for rotating the left arm about a longitudinal axis of the upper arm portion of the left arm; and
the right arm has an upper arm portion and a forearm portion, and the second shoulder joint comprises a fourth two-degree of freedom joint for rotating the right arm about x- and y-axes relative to the torso, and a third single degree of freedom joint for rotating the right arm about the longitudinal axis of the upper arm portion of the right arm.

11. The portable robot according to claim 10, wherein:
the first elbow joint comprises a fourth single degree of freedom joint for rotating the forearm of the left arm relative to the upper arm portion of the left arm about the y-axis, and a fifth single degree of freedom joint for rotating the forearm of the left arm relative to the upper arm portion of the left arm about a longitudinal axis of the forearm of the left arm; and
the second elbow joint comprises a sixth single degree of freedom joint for rotating a forearm of the right arm relative to the upper arm portion of the right arm about the y-axis, and a seventh single degree of freedom joint for rotating the forearm of the right arm relative to the upper arm portion of the right arm about a longitudinal axis of the forearm of the right arm.

12. The portable robot according to claim 1, wherein:
the first wrist joint comprises a first two-degree of freedom joint, allowing rotation of the left hand about the y- and z-axes relative to the left arm; and
the second wrist joint comprises a second two-degree of freedom joint, allowing rotation of the right hand about the y- and z-axes, relative to the right arm.

13. The portable robot according to claim 1, wherein:
the first little finger comprises a first single degree of freedom distal interphalangeal joint, a first single degree of freedom proximal interphalangeal joint and a first two-degree of freedom metacarpophalangeal joint for rotation of the first little finger around the y- and z-axes;
the first ring finger comprises a second single degree of freedom distal interphalangeal joint, a second single degree of freedom proximal interphalangeal joint and a second two-degree of freedom metacarpophalangeal joint for rotation of the first ring finger around the y- and z-axes;
the first middle finger comprises a third single degree of freedom distal interphalangeal joint, a third single degree of freedom proximal interphalangeal joint and a first single degree of freedom metacarpophalangeal joint for maintaining the first middle finger aligned with the first wrist joint in all positions;
the first index finger comprises a fourth single degree of freedom distal interphalangeal joint, a fourth single degree of freedom proximal interphalangeal joint and a third two-degree of freedom metacarpophalangeal joint for rotation of the first index finger around the y- and z-axes;
the first thumb includes a fifth single degree of freedom distal interphalangeal joint, a fifth single degree of freedom proximal interphalangeal joint and a second single degree of freedom metacarpophalangeal joint for maintaining the first thumb aligned with the first wrist joint in all positions at an angle substantially perpendicular to the first middle finger;
the second little finger comprises a sixth single degree of freedom distal interphalangeal joint, a sixth single degree of freedom proximal interphalangeal joint and a fourth two-degree of freedom metacarpophalangeal joint for rotation of the second little finger around the y- and z-axes;
the second ring finger comprises a seventh second single degree of freedom distal interphalangeal joint, a seventh single degree of freedom proximal interphalangeal joint and a fifth two-degree of freedom metacarpophalangeal joint for rotation of the second ring finger around the y- and z-axes;
the second middle finger comprises an eighth single degree of freedom distal interphalangeal joint, an eighth single degree of freedom proximal interphalangeal joint and a third single degree of freedom metacarpophalangeal joint for maintaining the second middle finger aligned with the second wrist joint in all positions;
the second index finger comprises a ninth single degree of freedom distal interphalangeal joint, a ninth single degree of freedom proximal interphalangeal joint and a sixth two-degree of freedom metacarpophalangeal joint for rotation of the second index finger around the y- and z-axes; and
the second thumb includes a tenth single degree of freedom distal interphalangeal joint, a tenth single degree of freedom proximal interphalangeal joint and a fourth single degree of freedom metacarpophalangeal joint for maintaining the thumb aligned with the second wrist joint in all positions at an angle substantially perpendicular to the second middle finger.

14. The portable robot according to claim 13, wherein;
the fifth single degree of freedom proximal interphalangeal joint and the second single degree of freedom metacarpophalangeal joint of the first thumb are at an acute angle a to one another, such that the first thumb crosses a center of a palm of the left hand; and
the tenth single degree of freedom proximal interphalangeal joint and the fourth single degree of freedom metacarpophalangeal joint of the second thumb are at the acute angle a to one another, such that the second thumb crosses a center of a palm of the right hand.

15. The portable robot according to claim 1, wherein:
the second display screen is a fully functional screen for the embedded mobile phone the speech processing module comprises a text-to-speech module and a speech-to-text module;
the 3D camera comprises means for outputting a video signal to the vision-based active recognition module;
the vision-based active recognition module comprises means for analyzing the video signal, means for recognizing and translating any recognized sign language actions and lip movements into translated words as a text signal, and means for sending the text signal to the text-to-speech module; and
the text-to-speech module comprises means for converting the text signal to an electrical audio output signal and means for sending the audio output signal to the speaker for sounding the translated words.

16-19. (canceled)
